(19) United States
(12) Patent Application Publication
(10) Pub. No.: US 2011/0127902 A1
(43) Pub. Date: Jun. 2, 2011

(54) Plasma Display Panel and Method of Manufacturing the Same

(76) Inventor: Gi-Young Kim, Yongin-si (KR)

(21) Appl. No.: 12/873,213

(22) Filed: Aug. 31, 2010

(30) Foreign Application Priority Data
Nov. 30, 2009 (KR) 10-2009-0117067

(51) Int. Cl. H01J 61/42; H01J 9/00

(52) U.S. Cl. 313/485; 445/24

(57) ABSTRACT

A plasma display panel including: a front substrate an opposing rear substrate; barrier ribs to form discharge cells between the front rear substrates; discharge electrodes disposed on the front substrate; address electrodes disposed on the rear substrate; and a phosphor layer disposed inside the discharge cells, covering the address electrodes. The phosphor layer includes a phosphor mixed with an intercalation agent having a smaller particle size than the phosphor.

### CROSS-REFERENCE TO RELATED APPLICATION

This application claims the benefit of Korean Patent Application No. 10-2009-0117067, filed on Nov. 30, 2009, in the Korean Intellectual Property Office, the disclosure of which is incorporated herein by reference.

### BACKGROUND

1. Field

One or more embodiments of the present disclosure relate to a plasma display panel and a method of manufacturing the same.

2. Description of the Related Art

Plasma display devices are flat panel display devices that display an image using plasma display panel to produce a gas discharge phenomenon. Plasma display devices have come into the spotlight as the next generation of large flat panel display devices, due to excellent display characteristics, such as, luminance, contrast, response speed, and viewing angle, and have thin profiles with large screen size.

In a plasma display panel, a discharge electrode (display electrode) is formed on an inner surface of a front glass substrate, wherein the discharge electrode includes a pair of transparent X and Y electrodes. A sustain discharge is generated between the X and Y electrodes, during operation of the plasma display panel.

An address electrode is formed on an inner surface of a rear glass substrate. The address electrode is covered by a dielectric layer, and a phosphor layer is formed on the dielectric layer. Since the phosphor layer and the dielectric layer are separately formed using separate materials, the efficiency of manufacturing the plasma display panel is decreased. Also, unnecessary materials remain after forming the phosphor layer and the dielectric layer, which affect discharge. As a result, improving of light emitting characteristics of the plasma display panel may be limited.

### SUMMARY

One or more exemplary embodiments of the present disclosure include a plasma display panel having increased light emission efficiency, and a method of manufacturing the same.

According to one or more embodiments of the present disclosure, provided is a plasma display panel including: a front substrate and an opposing rear substrate; barrier ribs to form discharge cells between the front substrate and the rear substrate; a plurality of discharge electrodes disposed on the front substrate and extending in parallel; a plurality of address electrodes disposed on the rear substrate and extending across the discharge electrodes; a phosphor layer disposed in the discharge cells, covering the address electrodes; and a discharge gas disposed inside the discharge cells. The phosphor layer includes phosphor particles and an intercalation agent.

According to one or more embodiments, the intercalation agent may be at least one selected from the group consisting of titanium dioxide (TiO₂), silicon dioxide (SiO₂), alumina (Al₂O₃), calcium sulfate (CaSO₄), sodium silicate, alumina silicate, calcium silicate, mercuric sulfide (HgS), copper carbonate (CuCO₃), copper hydroxide (Cu(OH)₃), arsenic disulfide (As₂S₂), lead oxide (Pb₃O₄), lead carbonate (PbCO₃), and calcium carbonate (CaCO₃).

According to one or more embodiments, the intercalation agent may include sub-phosphor particles that are smaller than the phosphor particles.

According to one or more embodiments, the average particle size of the intercalation agent may be from about 0.1 μm to about 1 μm.

According to one or more embodiments of the present disclosure, provided is a plasma display panel including: a front substrate and an opposing rear substrate; barrier ribs to form discharge cells between the front substrate and the rear substrate; a plurality of discharge electrodes disposed on the front substrate and extending in parallel; a plurality of address electrodes disposed on the rear substrate and extending across the discharge electrodes; a phosphor layer disposed inside the plurality of discharge cells, covering the address electrodes, and includes and intercalation agent having an average particle size from about 0.1 μm to about 1 μm; and a discharge gas disposed inside the discharge cells.

According to one or more embodiments of the present disclosure, a method of manufacturing a plasma display panel is provided, the method including: preparing a front substrate and a rear substrate that face each other; forming barrier ribs that define a space between the front substrate and the rear substrate into a plurality of discharge cells; forming a plurality of discharge electrodes on the front substrate, extending in parallel in a first direction; forming discharge electrodes on the rear substrate, extending in a second direction that is different from the first direction; forming a phosphor layer inside the plurality of discharge cells, to cover the plurality of address electrodes; and filling a discharge gas inside the plurality of discharge cells. The phosphor layer comprises a phosphor mixed with an intercalation agent.

According to various embodiments, the forming of the phosphor layer may include: separately applying a phosphor paste and a sub-phosphor paste to form a resultant; and plasticizing the resultant to form the phosphor layer.

According to various embodiments, the forming of the phosphor layer may include applying a phosphor paste, and then applying a sub-phosphor paste to the phosphor paste, or vice versa.

According to one or more embodiments of the present disclosure, a method of manufacturing a plasma display panel is provided, the method including: forming address electrodes on a rear substrate; forming barrier ribs on the rear substrate having discharge cells that expose the address electrodes; forming a plurality of discharge electrodes on a front substrate; forming a phosphor layer inside the plurality of discharge cells, so as to cover the plurality of address electrodes; and filling a discharge gas inside the plurality of discharge cells, while attaching the front and rear substrates, such that the discharge electrodes extend across the address electrodes. The phosphor layer includes an intercalation agent having an average particle size from about 0.1 μm to about 1 μm.

Additional aspects and/or advantages of the present disclosure will be set forth in part in the description which follows and, in part, will be obvious from the description, or may be learned by practice of the present disclosure.

### BRIEF DESCRIPTION OF THE DRAWINGS

These and/or other aspects and advantages of the present disclosure will become apparent and more readily appreciated from the following description of the exemplary embodiments, taken in conjunction with the accompanying drawings, of which:

FIGS. 1A and 1B are perspective views schematically illustrating a plasma display panel according to an exemplary embodiment of the present disclosure;

FIG. 2 is a cross-sectional view taken along a line II-II of FIGS. 1A and 1B;

FIGS. 3 through 5 are cross-sectional views for describing a method of manufacturing a plasma display panel, according to an exemplary embodiment of the present disclosure;

FIGS. 6 through 10 are cross-sectional views for describing a method of manufacturing a plasma display panel, according to another exemplary embodiment of the present disclosure; and

FIGS. 11 through 13 are cross-sectional views for describing a method of manufacturing a plasma display panel, according to another exemplary embodiment of the present disclosure.

### DETAILED DESCRIPTION

Reference will now be made in detail to the exemplary embodiments of the present disclosure, examples of which are illustrated in the accompanying drawings, wherein like reference numerals refer to the like elements throughout. The exemplary embodiments are described below, in order to explain the aspects of the present disclosure, by referring to the figures.

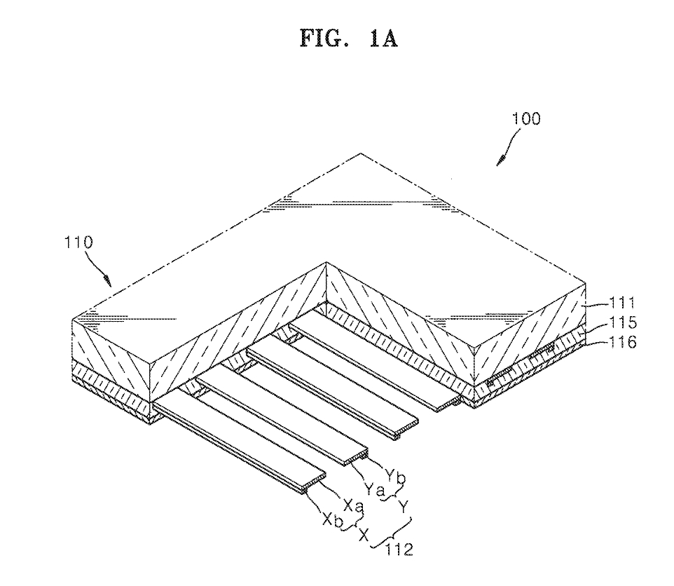

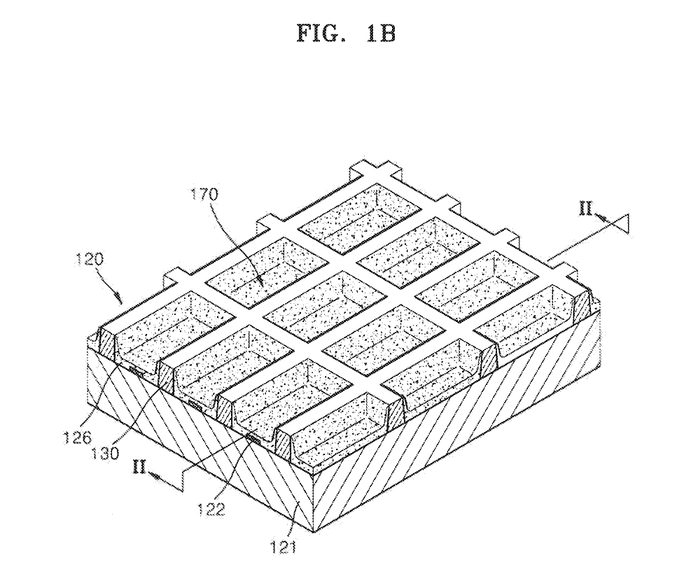

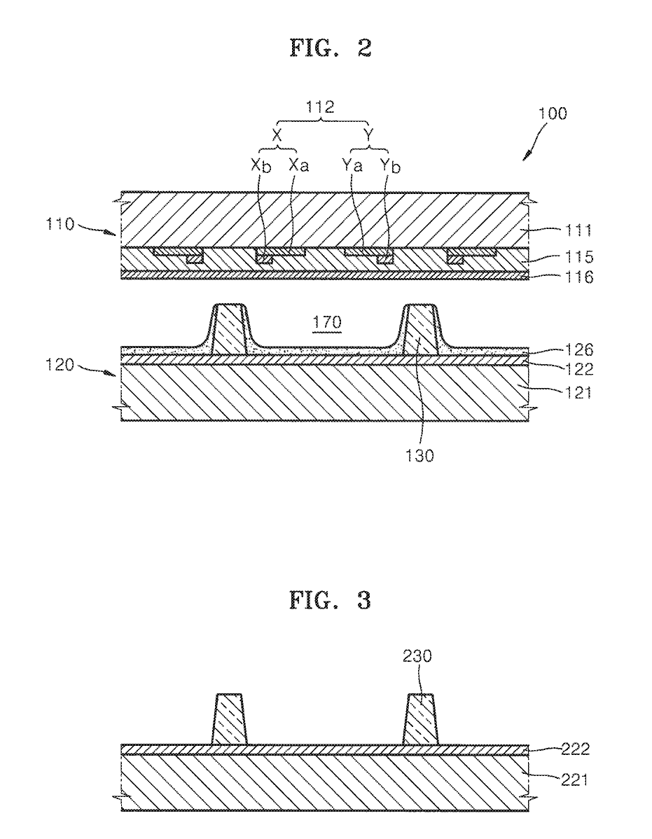

FIGS. 1A and 1B are perspective views schematically illustrating a plasma display panel 100 according to an ex embodiment of the present disclosure, and FIG. 2 is a cross-sectional view taken along a line II-II of FIGS. 1A. and 1B. Referring to FIGS. 1 and 2, the plasma display panel 100 includes a front panel 110 and an opposing rear panel 120. The front panel 110 includes a front substrate 111, discharge electrodes 112, a front dielectric layer 115, and a protective layer 116. The rear panel 120 includes a rear substrate 121, address barrier ribs 130, and a phosphor layer 126. A discharge gas is filled in a space between the front panel 110 and the rear panel 120. The structure of the plasma display panel 100 will now be described in detail.

The front substrate 111 may be generally formed of a material including glass, having a high permeability of visible light. However, the substrate 11 may be colored, so as to increase bright-room contrast.

The rear substrate 121 is spaced apart from, and faces, the front substrate 111. The rear substrate 121 may be formed of a material including glass, which may be colored so as to increase bright-room contrast, as in the front substrate 111.

The barrier ribs 130 are disposed between the front substrate 111 and the rear substrate 121. The barrier ribs 130 divide the space between the front substrate 111 and the rear substrate 121 into a plurality of discharge cells 170, and prevent optical/electrical crosstalk between the discharge cells 170. The barrier ribs 130 may partition the discharge cells 170 in a matrix shape. In detail, the discharge cells 170 are generally formed in a plurality of columns and a plurality of rows.

The discharge electrodes 112 are disposed on the front substrate 111. The discharge electrodes 112 each include an X electrode and a Y electrode that are spaced apart from each other and extend in parallel, along a first direction. The X and Y electrodes generate a discharge when a voltage is applied thereto, and each includes transparent electrodes Xa and Ya and bus electrodes Xb and Yb. The transparent electrodes Xa and Ya are formed of a conductive transparent material, such as indium tin oxide (ITO), for generating a discharge. Light emitted from the phosphor layer 126 is transmitted through the transparent electrodes Xa and Ya, to the front substrate 111. However, a transparent conductive material like ITO generally has a high resistance, and thus, when the discharge electrode 112 includes only the transparent electrodes Xa and Ya, lots of driving power is consumed and a response speed is delayed, due to a voltage drop that increases in accordance with increases in the length of the transparent electrodes Xa and Ya. Accordingly, the bus electrodes Xb and Yb, which are formed of a metal and have a narrow width, are disposed on the transparent electrodes Xa and Ya, respectively.

The transparent electrodes Xa and Ya, and the bus electrodes Xb and Yb are formed using a photo-etching method, a photo-lithography method, or the like. Here, the transparent electrodes Xa and Ya may have a long extended structure, a rectangular structure, or other structures. The bus electrodes Xb and Yb may be easily formed using an offset printing method.

The X and Y electrodes may be alternately disposed, or the same type of electrodes may be adjacently disposed between adjacent discharge cells 170. As shown in FIG. 2, the X and Y electrodes are disposed in an order of Y electrode, X electrode, X electrode, Y electrode, and so on, so that the same types of electrodes are adjacently disposed between adjacent discharge cells 170. Accordingly, mis-discharge, wherein a sustain discharge is generated over a boundary of the discharge cell 170, is prevented, consumption of reactive power is reduced, and driving efficiency is increased.

The front dielectric layer 115 is formed to cover the discharge electrodes 112 on the front substrate 111. The front dielectric layer 115 is formed so as to prevent the adjacent transparent electrodes Xa and Ya from applying a current to each other, while preventing electrons from damaging the discharge electrode 112, as the electrons directly collide with the discharge electrode 112. Also, the front dielectric layer 115 induces a charge, and thus, a wall charge is easily generated. The front dielectric layer 115 may be formed of a material mixed with a silicon dioxide (SiO₂), a lead oxide (PbO), or an aluminum oxide (Al₂O₃)-based ceramic having excellent insulation properties.

The protective layer 116 may be formed on the front dielectric layer 115 of the front substrate 111. The protective layer 116 is formed in order to prevent the front dielectric layer 115 from being damaged, as cations and electrons collide on the front dielectric layer 115 when the plasma display panel 100 discharges, and to increase emission of secondary electrons in the discharge cell 170. The protective layer 116 may be formed of a material including magnesium oxide (MgO), which is a strong dielectric having excellent internal voltage characteristics. The protective layer 116 is generally formed by using a sputtering method, an electron beam deposition method, or the like.

The address electrodes 122 are formed on the rear substrate 121, in a predetermined pattern. The address electrodes 122 are formed across the discharge cells 170, so as to cross the discharge electrodes 112 of the front substrate 111, in a second direction. The address electrodes 122 generate address discharges to facilitate the generation of sustain discharges between the discharge electrodes 112 and in detail, decrease a voltage for generating sustain discharges.

The phosphor layer 126 is formed to cover the address electrodes 122. The phosphor layer 126 includes a phosphor and an intercalation agent. The phosphor layer 126 includes a component that generates visible light from vacuum ultraviolet light. The phosphor layer 126 may include a red, green, or blue phosphor, according to each discharge cell 170.

The red phosphor may include Y(V, P)O₄:Eu, the green phosphor layer 126 may include Zn₂SiO₄:Mn or YBO₃:Tb, and the blue phosphor layer may include BAM:Eu, for example. The phosphor layer 126 covers the address electrodes 122, to insulate and protect the address electrode 122.

The intercalation agent is mixed with the phosphor, to increase the density of the phosphor layer 126. Accordingly, particles of the intercalation agent fill gaps between particles of the phosphor.

The intercalation agent may be any one selected from the group consisting of titanium dioxide (TiO₂), silicon dioxide (SiO₂), alumina (Al₂O₃), calcium sulfate (CaSO₄), sodium silicate, alumina silicate, calcium silicate, mercuric sulfide (HgS), copper carbonate (CuCO₃), copper hydroxide (Cu(OH)₃), arsenic disulfide (As₂S₂), lead oxide (Pb₃O₄), lead carbonate (PbCO₃), and calcium carbonate (CaCO₃).

Generally, a phosphor has a low density, due to the characteristics thereof. Accordingly, when the address electrode 122 is covered only with the phosphor layer 126, the address electrode 122 is not sufficiently insulated during discharge of the discharge cell 170, and thus, discharge characteristics of the address electrode 122 are degraded.

However, according to the current embodiment of the present disclosure, the intercalation agent is mixed with the phosphor, thereby filling gaps between the particles of the phosphor. Thus, the density of the phosphor layer 126 is increased.

Accordingly, the intercalation agent may have a particle size from about 0.1 μm to about 1 μm. When the particle size is smaller than 0.1 μm, it is difficult to form the intercalation agent, and particles of the intercalation agent may not be uniform. Accordingly, the particle size may be 0.1 μm or higher.

When the particle size of the intercalation agent exceeds 1 μm, it is difficult to fill the gaps between particles of the phosphor. Specifically, when the particle size of the intercalation agent exceeds 1 μm, the intercalation rate of the intercalation agent particles into the phosphor particles decreases, and coherence between the phosphor particles and the intercalation agent particles decreases. Accordingly, the particle size of the intercalation agent may be 1 μm or less, even when a plasticization process is used to form the phosphor layer 126.

The phosphor layer 126 is formed through a plasticization process. Here, the intercalation agent should not decompose at a general plasticization temperature, i.e., a temperature of about 480° C.

The TiO₂, HgS, CuCO₃, Cu(OH)₃, As₂S₂, Pb₃O₄, PbCO₃, and CaCO₃ intercalation agent materials may operate as a pigment (sub-phosphor) for improving the color efficiency of the phosphor. A sub-phosphor that is smaller than the phosphor may be used as the intercalation agent. Particles of the sub-phosphor may be intercalated into the gaps of the low density phosphor particles, so as to increase the density of the phosphor layer 126. The particle size of the sub-phosphor may be from about 0.1 μm to about 1 μm, like the particles of the intercalation agent. Alternatively, instead of using the intercalation agent, a phosphor layer having a particle size from about 0.1 μm to about 1 μm may be formed. Details thereof will be described later.

Generally, a rear dielectric layer is formed to cover address electrodes, after forming the address electrodes, Accordingly, process efficiency may decrease, and light emitting efficiency may decrease. However, according to the current embodiment of the present disclosure, the phosphor layer 126 is formed to cover the address electrodes 122, without a separate rear dielectric layer, thereby resulting in an increase in process efficiency and light emitting efficiency. Specifically, the phosphor layer 126 has a high density, since the phosphor layer 126 is formed by mixing the phosphor and the intercalation agent. Accordingly, the address electrodes 122 are safely insulated and protected, and have improved discharge characteristics, without the need for a rear dielectric layer.

A discharge gas including a mixture of neon (Ne) and xenon (Xe) is filled in the discharge cells 170. The discharge gas may include more Xe than Ne. The discharge gas is filled in the discharge cells 170, when the front substrate 111 and the rear substrate 121 are sealed together with a sealing member (not shown), such as a frit glass. The sealing member is disposed on the edges of the front substrate 111 and the rear substrate 121.

Operations and effects of the plasma display panel 100 will now be described. An address discharge is generated by applying an address voltage to the address electrode 122 and the Y electrode of the discharge electrode 112. As a result of the address discharge, the discharge cell 170 is selected for generating sustain discharge. The address discharge is a type of subsidiary discharge that facilitates the formation of the sustain discharge, by accumulating priming particles inside the selected discharge cell 170.

The Y electrode and the address electrode 122 cross each other, and a discharge voltage, applied between the Y electrode and the address electrode 122, is concentrated in the discharge cell 170 through the phosphor layer 126, thereby forming a high electric field for initiating discharge. Here, the high density of the phosphor layer 126 maintains the insulation properties of the phosphor layer 126, even when the high electric field is formed. The thickness of the phosphor layer 126 may be suitably determined, according to a method of forming the plasma display panel 100, and the size and standard of the plasma display panel 100.

The sustain discharge is generated when a sustain voltage is applied between the X electrode and Y electrode of the discharge electrode 112, in the selected discharge cell 170. The sustain discharge excites the discharge gas. The discharge gas emits ultraviolet light, when the discharge gas returns to a ground state. Then, the ultraviolet light excites the phosphor layer 126 coated inside the discharge cell 170. The excited phosphor layer 126 returns to a ground state, by emitting visible light. Accordingly, the emitted visible light is used to form an image. The visible light is transmitted through the front panel 110, to be recognized by the eyes of a viewer.

FIGS. 3 through 5 are cross-sectional views for describing a method of manufacturing a plasma display panel 200, according to an exemplary embodiment of the present disclosure. Referring to FIG. 3, a plurality of address electrodes 222 and barrier ribs 230 are formed on a rear substrate 221. The rear substrate 221 may be formed of a material including glass, which may be colored for high bright-room contrast. The address electrodes 222 are formed on the rear substrate 221, in a predetermined pattern. The barrier ribs 230 are formed on the address electrodes 222.

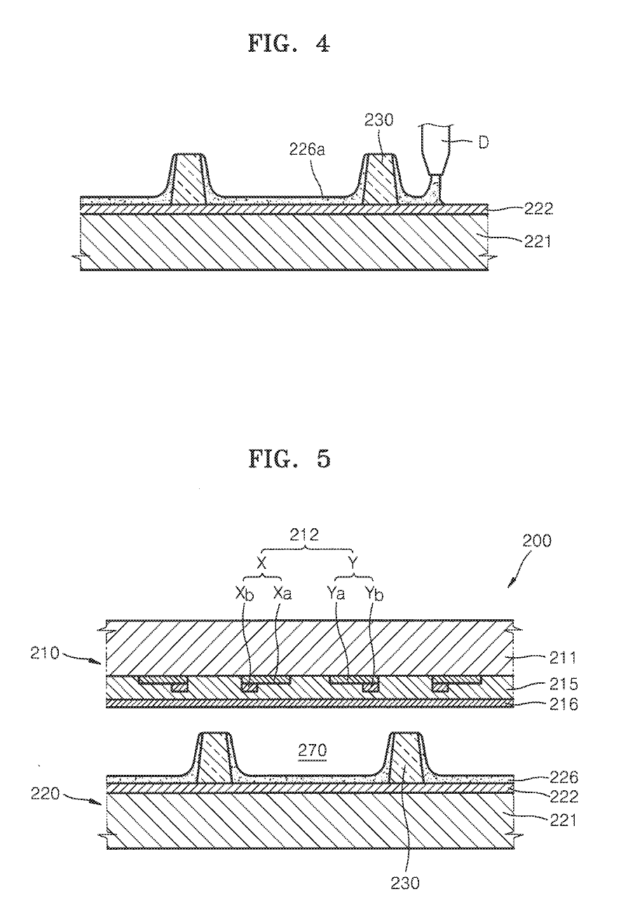

Then, in order to form a phosphor layer 226, a phosphor layer paste 226a is applied to cover the address electrodes 222. Referring to FIG. 4, the phosphor layer paste 226a is applied to address electrodes 222 using a dispenser D. As such, the phosphor layer paste 226a may be continuously applied in each discharge cell 170 of FIG. 1.

The phosphor layer paste 226a is a mixture of a phosphor paste and an intercalation agent. The phosphor paste may include a red, green, or blue phosphor. The phosphors may be as described above.

The intercalation agent may be any one selected from the group consisting of TiO₂, SiO₂, Al₂O₃, CaSO₄, sodium silicate, alumina silicate, calcium silicate, HgS, CuCO₃, Cu(OH)₃, As₂S₂, Pb₃O₄, PbCO₃, and CaCO₃. As the intercalation agent is mixed with the phosphor paste, the intercalation agent fills gaps between the phosphor particles. Thus, the phosphor layer paste 226a has a high density. The particle size of the intercalation agent may be from about 0.1 μm to about 1 μm.

A plasticization process is performed after applying the phosphor layer paste 226a, to further intercalate the intercalation agent particles into the phosphor particles. As a result a uniform phosphor layer 226 having a high density is formed, as shown in FIG. 5. Thereby fabricating the plasma display panel 200.

The plasticization process is generally performed at a high temperature. Accordingly, the intercalation agent should not decompose at the high temperature. In detail, the intercalation agent should not decompose at a general plasticization temperature of about 480° C.

Referring to FIG. 5, the plasma display panel 200 includes a front panel 210 and an opposing rear panel 220. The front panel 210 includes a front substrate 211, discharge electrodes 212, a front dielectric layer 215, and a protective layer 216. The rear panel 220 includes the rear substrate 221, the address electrodes 222, the barrier ribs 230, and the phosphor layer 226. The space between the front panel 210 and the rear panel 220 is filled with a discharge gas.

While the discharge gas is filled, the front substrate 211 and the rear substrate 221 are sealed together with a sealing member (not shown), such as a frit glass. The sealing member is formed on edges of the front substrate 211 and the rear substrate 221. The elements of the plasma display panel 200 are identical to those of the plasma display panel 100, and thus, descriptions thereof are not repeated.

According to the current embodiment of the present disclosure, the phosphor layer 226 is formed to cover the address electrode 222, without using a separate rear dielectric layer. Accordingly, process efficiency and light emitting efficiency are increased. Also, since the phosphor layer paste 226a is used, the phosphor layer 226 has a high density. Also, the plasticization process further increases the density of the phosphor layer 226. Accordingly, the address electrode 222 is safely insulated and protected, and has excellent discharge characteristics.

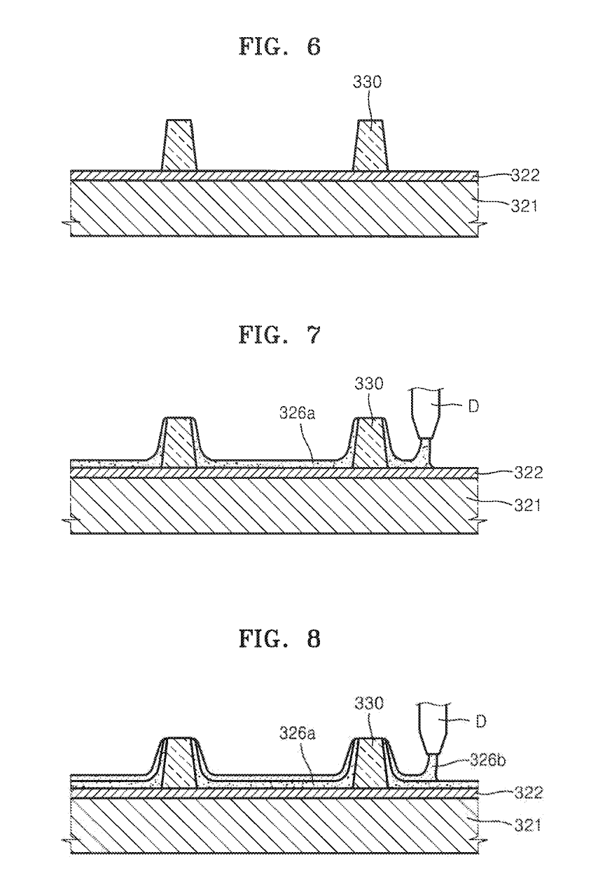

FIGS. 6 through 10 are cross-sectional views illustrating a method of manufacturing a plasma display panel 300, according to another exemplary embodiment of the present disclosure. Referring to FIG. 6, a plurality of address electrodes 322 and barrier ribs 330 are formed on a rear substrate 321. The rear substrate 321 may be formed of a material including glass that may be colored for high bright-room contrast. The address electrode 322 is formed on the rear substrate 321, in a predetermined pattern. The barrier ribs 330 are formed on the address electrode 322.

Then, a phosphor layer paste 326a is applied on the address electrode 322, so as to form a phosphor layer 326. Referring to FIG. 7, the phosphor layer paste 326a is applied to cover the address electrode 322 using a dispenser D. Referring to FIG. 8, after applying the phosphor layer paste 326a, a sub-phosphor paste 326b is applied on the phosphor layer paste 326a using the dispenser D. The phosphor layer paste 326a and the sub-phosphor paste 326b may include phosphors that emit the same color.

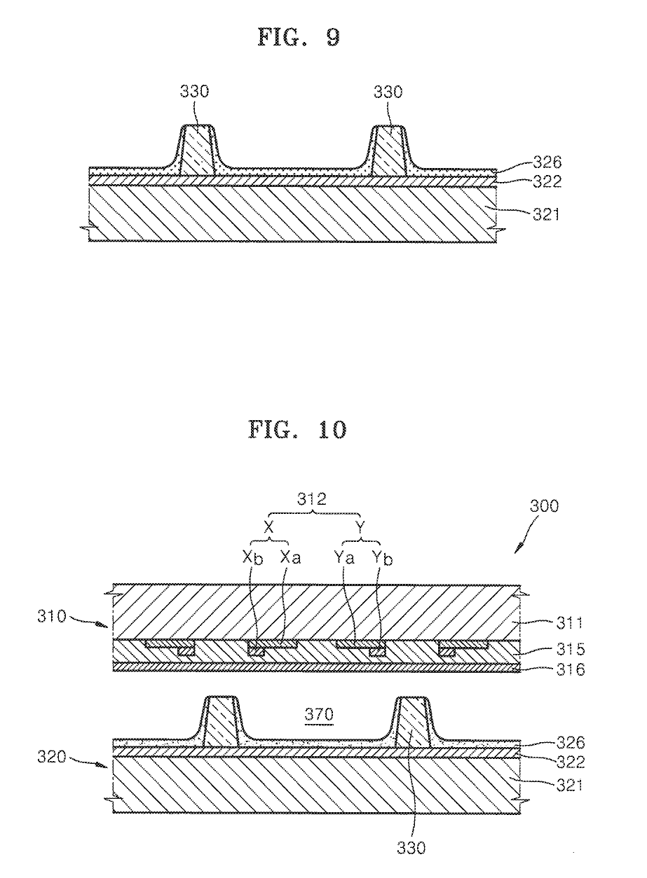

Then, referring to FIG. 9, the phosphor layer 326 is formed through a plasticization process. Particles of the sub-phosphor paste 326b are smaller than particles of the phosphor layer paste 326a. Specifically, the particle size of the sub-phosphor paste 326b may be from about 0.1 μm to about 1 μm. During the plasticization process, the particles of the sub-phosphor paste 326b are filled in gaps of the particles of the phosphor layer paste 326a. Accordingly, the sub-phosphor paste 326b operates as an intercalation agent, and as a result, the phosphor layer 326 that is highly dense is easily formed.

Referring to FIG. 10, the phosphor layer 326 is formed accordingly, and the plasma display panel 300 that is completed manufactured is illustrated. The plasma display panel 300 includes a front panel 310 and a rear panel 320 that are combined facing each other. The front panel 310 includes a front substrate 311, discharge electrodes 312, a front dielectric layer 315, and a protective layer 316. The rear panel 320 includes the rear substrate 321, the address electrode 322, the barrier ribs 330, and the phosphor layer 326. The space between the front panel 310 and the rear panel 320 is filled with a discharge gas.

The discharge gas is filled when the front substrate 311 and the rear substrate 321 are sealed together by a sealing member (not shown), such as a frit glass, that is applied to edges of the front substrate 311 and the rear substrate 321. The elements of the plasma display panel 300 are identical to those of the plasma display panel 100, and thus, descriptions thereof are not repeated.

In the current embodiment of the present disclosure, the phosphor layer paste 326a is applied, and then the sub-phosphor paste 326b having smaller particles than the phosphor layer paste 326a is applied. Alternatively, the plasticization process may be performed by applying the sub-phosphor paste 326b and then applying the phosphor layer paste 326a. Here, the particles of the sub-phosphor paste 326b are intercalated between the particles of the phosphor layer paste 326a. Thus the phosphor layer 326 having a high density may be formed.

FIGS. 11 through 13 are cross-sectional views illustrating a method of manufacturing a plasma display panel 400, according to another exemplary embodiment of the present disclosure. Referring to FIG. 11, a plurality of address electrodes 422 and barrier ribs 430 are formed on a rear substrate 421. The address electrodes 422 are formed on the rear substrate 421 in a predetermined pattern. The barrier ribs 430 are formed on the address electrodes 422.

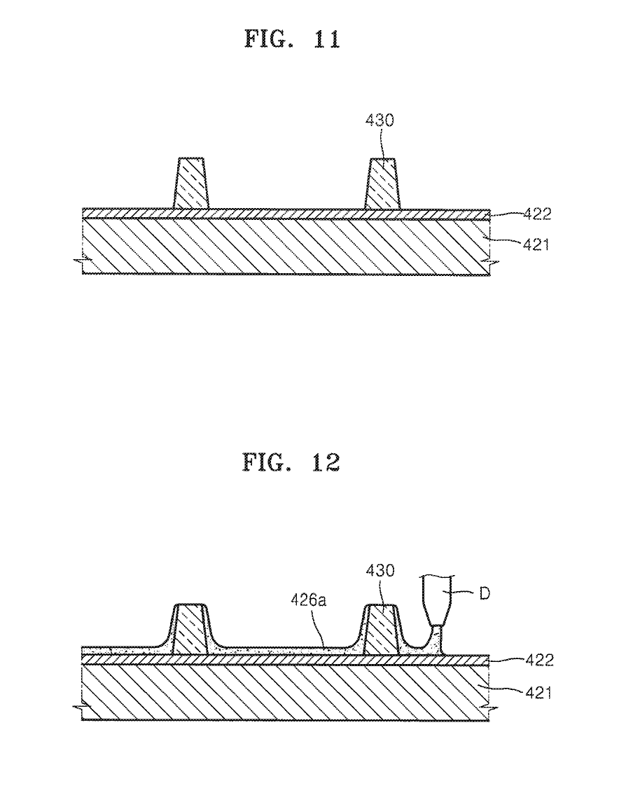

Then, a phosphor layer paste 426a is applied on the address electrodes 422, so as to form a phosphor layer 426. Referring to FIG. 12, the phosphor layer paste 426a is applied to cover the address electrode 422 using a dispenser D. The particle size of the phosphor layer paste 426a may be from about 0.1 μm to about 1 μm. The phosphor layer paste 426a may include a red, green, or blue phosphor.

The red phosphor may include Y(V,P)O₄:Eu, the green phosphor may include Zn₂SiO₄:Mn or YBO₃:Tb, and the blue phosphor may include BAM:Eu, for example. The phosphor layer paste 426a has a particle size of 1 ml or less.

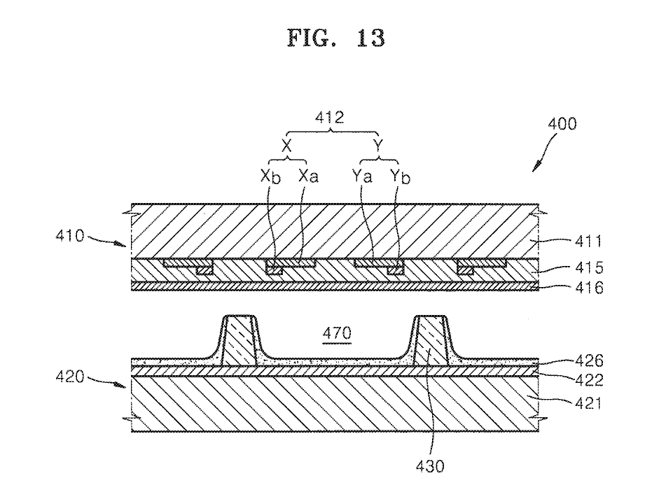

When a plasticization process is performed after applying the phosphor layer paste 426a having the minute particles, the minute particles aggregate with each other, so as to form the phosphor layer 426 having a high density. Referring to FIG. 13, the phosphor layer 426 is formed accordingly, thereby completing the plasma display panel 400.

Referring to FIG. 13, the plasma display panel 400 includes a front panel 410 and a rear panel 420 that are combined facing each other. The front panel 410 includes a front substrate 411, discharge electrodes 412, a front dielectric layer 415, and a protective layer 416. The rear panel 420 includes the rear substrate 421, the address electrodes 422, the barrier ribs 430, and the phosphor layer 426. The space between the front panel 410 and the rear panel 420 is filled with a discharge gas.

While the discharge gas is filled, the front substrate 411 and the rear substrate 421 are combined and sealed by a sealing member (not shown), such as a frit glass. The sealing member is applied to edges of the front substrate 411 and the rear substrate 421. The elements of the plasma display panel 400 are identical to those of the plasma display panel 100 of the previous embodiment. Thus descriptions thereof are not repeated.

As described above, according to the one or more of the above exemplary embodiments of the present disclosure, the number of operations in the method of manufacturing a plasma display panel may be reduced, and the discharge efficiency of the plasma display panel may be improved.

Although a few exemplary embodiments of the present disclosure have been shown and described, it would be appreciated by those skilled in the art that changes may be made in these exemplary embodiments, without departing from the principles and spirit of the present disclosure, the scope of which is defined in the claims and their equivalents.

What is claimed is:

1. A plasma display panel comprising:
a front substrate and an opposing rear substrate;
barrier ribs disposed between the front and rear substrates, forming discharge cells;
discharge electrodes disposed in parallel, on the front substrate;
address electrodes disposed on the rear substrate, extending across the discharge electrodes;
a phosphor layer disposed inside the discharge cells, covering the address electrodes, and comprising a phosphor mixed with an intercalation agent; and
a discharge gas disposed inside the discharge cells.

2. The plasma display panel of claim 1, wherein the intercalation agent is at least one selected from the group consisting of titanium dioxide (TiO₂), silicon dioxide (SiO₂), alumina (Al₂O₃), calcium sulfate (CaSO₄), sodium silicate, alumina silicate, calcium silicate, mercuric sulfide (HgS), copper carbonate (CuCO₃), copper hydroxide (Cu(OH)₃), arsenic disulfide (As₂S₂), lead oxide (Pb₃O₄), lead carbonate (PbCO₃), and calcium carbonate (CaCO₃).

3. The plasma display panel of claim 1, wherein the intercalation agent comprises a sub-phosphor having a smaller average particle size than the phosphor.

4. The plasma display panel of claim 1, wherein the average particle size of the intercalation agent is from about 0.1 μm to about 1 μm.

5. A plasma display panel comprising:
a front substrate and an opposing rear substrate;
barrier ribs that define a space between the front substrate and the rear substrate into discharge cells;
discharge electrodes disposed on the front substrate;
address electrodes disposed on the rear substrate, extending across the discharge electrodes;
a phosphor layer disposed inside the discharge cells, covering the address electrodes, and comprising an intercalation agent having an average particle size from about 0.1 μm to about 1 μm; and
a discharge gas disposed inside the discharge cells.

6. A method of manufacturing a plasma display panel, the method comprising:
forming address electrodes on a rear substrate
forming barrier ribs on the rear substrate, having discharge cells that expose the address electrodes;
forming discharge electrodes on a front substrate;
forming a phosphor layer in the discharge cells, so as to cover the address electrodes, the phosphor layer comprising a phosphor mixed with an intercalation agent; and
filling a discharge gas inside the discharge cells, and attaching the front substrate to the rear substrate, such that the discharge electrodes extend across the address electrodes.

7. The method of claim 6, wherein the intercalation agent comprises at least one selected from the group consisting of titanium dioxide (TiO₂), silicon dioxide (SiO₂), alumina (Al₂O₃), calcium sulfate (CaSO₄), sodium silicate, alumina silicate, calcium silicate, mercuric sulfide (HgS), copper carbonate (CuCO₃), copper hydroxide (Cu(OH)₃), arsenic disulfide (As₂S₂), lead oxide (Pb₃O₄), lead carbonate (PbCO₃), and calcium carbonate (CaCO₃).

8. The method of claim 6, wherein the average particle size of the intercalation agent is from about 0.1 μm to about 1 μm.

9. The method of claim 6, wherein the intercalation agent comprises a sub-phosphor having a smaller average particle size than the phosphor.

10. The method of claim 9, wherein the forming of the phosphor layer comprises:
separately applying a phosphor paste and a sub-phosphor paste, to form a resultant; and
plasticizing the resultant to form the phosphor layer.

11. The method of claim 10, wherein the sub-phosphor paste is applied after the phosphor paste is applied.

12. The method of claim 10, wherein the phosphor paste is applied after the sub-phosphor paste is applied.

13. A method of manufacturing a plasma display panel, the method comprising:
forming address electrodes on a rear substrate;
forming barrier ribs on the rear substrate, having discharge cells that expose the address electrodes;
forming discharge electrodes on a front substrate;
forming a phosphor layer inside the discharge cells, so as to cover the address electrodes, the phosphor layer comprising an intercalation agent having an average particle size of from about 0.1 μm to about 1 μm; and
filling a discharge gas inside the discharge cells, and attaching the front substrate to the rear substrate, such that the discharge electrodes extend across the address electrodes.

14. A plasma display panel comprising:
a front substrate and an opposing rear substrate;
discharge electrodes disposed on the front substrate;
address electrodes disposed on the rear substrate;
barrier ribs disposed on the rear substrate, forming discharge cells that expose the address electrodes;
a phosphor layer disposed in the discharge cells, covering the address electrodes, and comprising a phosphor having a first average particle size and an intercalation agent having a second average particle size that is smaller than the first average particle size; and
a discharge gas disposed in the discharge cells.

15. The plasma display panel of claim 14, wherein the intercalation agent particles are intercalated into the phosphor particles, and have an average particle size of from about 0.1 μm to about 1 μm.

16. The plasma display panel of claim 14, wherein the intercalation agent particles are intercalated into the phosphor particles, via heat plasticization.

17. The plasma display panel of claim 14, wherein the intercalation agent comprises a sub-phosphor.
